(19) United States
(12) Patent Application Publication
(10) Pub. No.: US 2022/0247659 A1
(43) Pub. Date: Aug. 4, 2022

(54) CLOUD NETWORK HEALTH CHECK TAGS

(71) Applicant: SAP SE, Walldorf (DE)

(72) Inventors: Shenol Hulmi Yousouf, Sofia (BG); Antoan Nikolaev Andonov, Burgas (BG); Kaloyan Stefanov Nikov, Veliko Tarnovo (BG)

(21) Appl. No.: 17/163,798

(22) Filed: Feb. 1, 2021

(51) Int. Cl. H04L 12/26

(52) U.S. Cl. CPC H04L 43/12; H04L 43/062; H04L 43/10; H04L 43/028; H04L 43/045

(57) ABSTRACT

In an example embodiment, a monitoring framework for detecting network issues between different cloud segments is provided. The backbone of this framework is a network mesh of web agents that are installed and distributed across multiple locations, such as in many or even all accessible network segments of a data center and in various locations external to the data center.

### TECHNICAL FIELD

This document generally relates to systems and methods for use in cloud computing. More specifically, this document relates to cloud network health check tags.

### BACKGROUND

Cloud landscapes often suffer from problems caused by disruptions in network connectivity, failing hardware, etc. that could lead to significant downtime in provided services or customer applications. Some outages, however, may apply only to specific segments of the cloud infrastructure or specific scenarios while other segments may go on uninterrupted. For example, services and applications are usually deployed in different segments and it is entirely possible (e.g. through an unintentional error in the configuration of a firewall rule, crashed hypervisor, etc.) that only one of these segments is experiencing problems while the other segments are working perfectly fine.

In such cases, it is important to be aware not only of the overall health status of the whole landscape at the macro level or of the individual issues of specific VMs, services, etc. at the micro level but the status of entities that fall somewhere between these two granularities. For example, these entities could involve network segments or even the execution of specific scenarios, etc. It would also be helpful to be able to receive answers to specific questions like. “are the application databases accessible?”, “are applications/services accessible from Internet?”, “can core services talk with the application VMs for their management?” and so on.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating multiple web agents in accordance with an example embodiment.

FIG. 2 is a block diagram illustrating a single data center architecture in accordance with an example embodiment.

FIG. 3 is a block diagram illustrating a single data center architecture in accordance with an example embodiment.

FIG. 4 is a screen capture illustrating a graphical user interface for displaying health check data in accordance with an example embodiment.

FIG. 5 is a screen capture illustrating a graphical user interface for displaying health check data in accordance with another example embodiment.

FIG. 6 is a flow diagram illustrating a method for generating health check data in a data center, in accordance with an example embodiment.

FIG. 7 is a block diagram illustrating an architecture of software, which can be installed on any one or more of the devices described above.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

In an example embodiment, a monitoring framework for detecting network issues between different cloud segments is provided. The backbone of this framework is a network mesh of web agents that are installed and distributed across multiple locations, such as in many or even all accessible network segments of a data center (internal web agents) and in various locations external to the data center (external web agents).

The web agents perform simple requests, over network protocols such as Transmission Control Protocol (TCP) and Hypertext Transfer Protocol (HTTP), to other web agents, thus forming a full network mesh that covers connectivity between different network segments inside the same data center, from the Internet to the segment that is externally accessible, and from various network segments to the internet. In addition, in multi-data center platforms, the web agents can additionally cover connectivity between network segments from the different data centers.

The health check data is served to upper layers of the solution, which are responsible for its aggregation, analysis, and presentation as a health status picture of the entire cloud landscape.

In the aggregation phase, however, the information about the source of the health check results from which a particular piece of data is coming and the exact nature of the health check could be lost. For example, during aggregation, the information that the particular data came from a web agent testing connectivity from segment A to segment B on port 1234 via TCP may be lost. In order to prevent this, in an example embodiment each web agent adds tags to the health check data as metadata. The tags include the source and destination of the health check data and the nature of the health check. In an example embodiment, this includes an identification of the network portion on which the health check was performed (e.g., segment A to segment B), the protocol that is run (e.g. HTTP), and the port on which the network portion lies (e.g., port 1234).

In an example embodiment, the metadata information may be in the form of multiple tags at various different levels of granularity. For example, if the metadata information includes 3 pieces of information (segment A-segment B, TCP, port 1234), then one tag may be generated comprising all 3 pieces of information (“A-to-B-tcp-1234”) while other tags can be generated having various combinations of the information using fewer than all 3 pieces of information (e.g., A-to-B-tcp”, “A-to-B”, and “A-to-B-1234”). Thus, when all the health check data is pushed to the aggregation layer, some of the health check tags will be quite unique as coming from specific web agents, but other tags may be shared by many agents. This allows for the services that have access to all the collected health check data to executed different types of queries on it, from more specific to more general. For example, the request “give me the whole health check data concerning the connectivity between segment A and segment B” can be executed as a query for health check data by tag “A-to-B’. Based on the information retrieved in this manner, various kinds of analysis about the health status of one or another segment, user case scenario, and so on may follow.

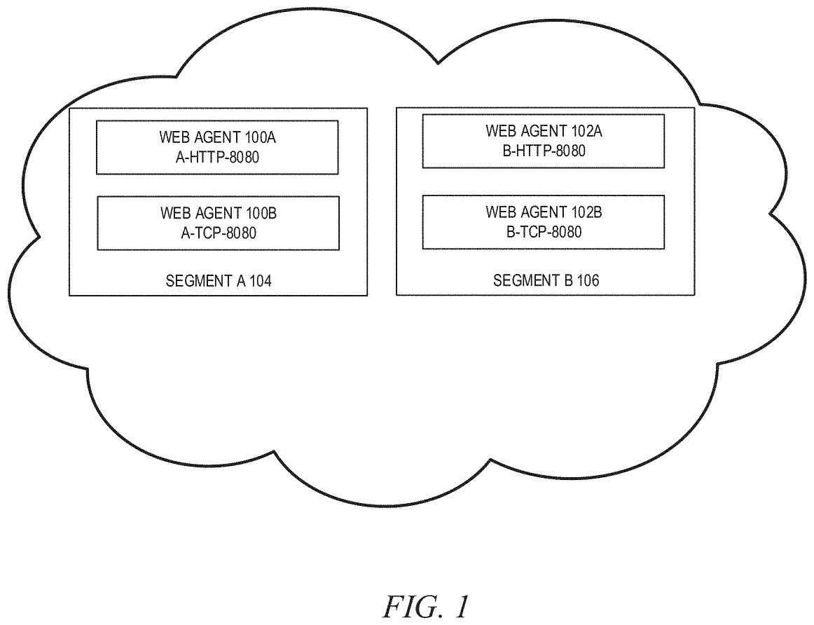

FIG. 1 is a block diagram illustrating multiple web agents 100A, 100B, 102A, 102B in accordance with an example embodiment. As can be seen, both web agent 100A and web agent 100B reside in segment A 104 of a cloud environment, while web agent 102A and 102B reside in segment B 106 of the cloud environment. Each web agent 100A, 100B, 102A, 102B may be specific to a particular segment, port, and protocol. For example, web agent 100A covers segment A, the HTTP protocol, and port 8080 and while web agent 100B covers segment A, the TCP protocol, and port 8080.

Web agent 100A may generate tags such as “A-to-B-htttp-8080,” “A-to-B-8080,” “A-to-B-http,” and “A-to-B.” Web agent 102A may generate tags such as “B-to-A-htttp-8080”, “B-to-A-8080,” “B-to-A-http,” and “B-to-A.” Similar tags may be generated by web agents 100B and/or web agent 102B for detecting problems on the TCP and HTTP side.

Although the examples given above are related primarily to obtaining the connectivity status in various points of the cloud landscapes and they may seem to hint at one possible format of the health check tags, in fact, there are no restrictions what kind of tags could be assigned to any health check. For example, one web agent may regularly execute a specific health check test and may be instructed to assign a custom tag to the results from this test like “mySpecificHealthCheck”. The health check test procedures (e.g. in the form of scripts, etc.) as well as the tags that the web agent is instructed to add to the health check metadata can be specified and configured during the installation of the agent itself.

This model gives opportunity to the stakeholders of the solution to request their own kind of health checks tagged with a label that (only) they can recognize. Then they can make queries to the aggregation or analytical services by this health check tag to get the results they are concerned with. This offers a great flexibility and extensibility for the solution since it is not limited to a fixed set of health checks and tags for queries.

Each web agent is a small lightweight application deployed (on a virtual machine, in a container, or on another host type) inside or outside of a cloud platform. There may be different types of web agents, testing various parts of the network and various basic scenarios in the platform. After receiving the information provided by the web agents, a data center health service can aggregate the information and expose it to interested parties.

The implementation of the data center health service may utilize one of many different architectures. For example, the data center health service can either poll the web agents for the health check status or wait for the web agents to push the information to the data center health service at regular intervals. One advantage of the polling implementation is that the data center health service knows which web agents to ping and then it can detect cases where a web agent itself is not responding, is inaccessible, or is dead.

Additionally, various implementations could be used for the data center health service to discover web agents. In a first such embodiment, the data center health service is configured with a predefined list of web agent endpoints and then contacts them directly. This allows for a list of web agents to be known in advance and kept in one service and, if there are several data center health service nodes running in different regions, there is precise control over distribution of web agents among the service nodes. Additionally, the web agents don't need to implement logic for their dynamic discovery or registration with the data center health service. On the other hand, the process for adding new web agents is more complex and uses an update of the data center health service configuration. Additionally, it can make it difficult for the data center health service to distinguish cases where the web agent is not responding with cases where it is stopped or removed intentionally, as the latter case makes use of a process to deregister web agents on demand.

In a second such embodiment, web agents are added or removed dynamically to avoid frequent updates of the data center health service configuration. The web agents may register with the data center health service upon start, through a registration application program interface (API), and then the data center health service will begin to poll them. During registration, the web agents can declare various parameters about the communication protocol, such as a web agent identification by which the web agent can be uniquely identified, what type of information can be obtained from the web agent, how the information is obtained (e.g., through Representational State Transfer (REST) endpoint Uniform Resource Locator (URL), how often to be polled, etc. The on-the-fly registration provides flexibility in adding new health checks or removal of others without the data center health service having knowledge as to what endpoints to call in advance. Additionally, a registration API exposed for these purposes also opens up the possibility of third-party components for the web agents to deploy and register/unregister agents on their behalf. On the other hand, the web agents then implement registration logic on start and de-registration logic on stop, which adds complexity to the lightweight web agents.

In a third such embodiment, the registration of web agents is the responsibility of another service, which provisions them and registers them in the data center health service afterwards. Accordingly, the service unregisters the agents before uninstalling them. This approach uses a definition of a web agents registration API, which is accessible only to the service for installing web agents. This approach allows web agent installation and registration to be performed back-to-back, which aids the reliability of registration information. Additionally, web agents are offloaded from implementing a registration logic on start and from the knowledge where the data center health service is located. Installation and updates of web agents is a responsibility of a separate entity. This approach also opens up the possibility that if the data center health service detects that a certain web agent is not responding, to notify the registration service to re-provision it. On the other hand, implementation of an additional service is needed for the maintenance of the data center health service infrastructure in this approach.

Additionally, in most cases the web agents can be stopped gracefully so that they have sufficient time to notify the data center health service to stop polling them. This helps mitigate false positive cases where the service considers the web agent dead or inaccessible because of a network issue. It is used even if one assumes that there is a registration service that unregisters the web agents on removal as there is no guarantee that a web agent cannot be stopped in any other way.

However, one cannot avoid cases where the web agents crash and/or stop responding (such as because of a load created on a hypervisor where they are hosted). One cannot rely on having a single web agent responsible for a particular health check. For this reason, in an example embodiment, multiple web agents are responsible for a given health check.

However, this leads to the possibility that there are conflicting statuses for the same health check. One of three approaches may be used to resolve such situations. In the first, the data center health service analyzes the collected information and exposes an overall status based upon pre-defined rules, such as that the overall health check status is the one that is reported by more than half or two thirds of the responding web agents. The consumers do not know about the statuses reported by each web agent. In the second, the data center health service exposes the full information collected by all web agents, and lets the consumers of this information interpret it according to their own logic. The payload of this information may be quite large. In the third, a mixed approach is used where detailed health check status information is provided based on some rules, but multiple statuses are still reported for the consumer to evaluate.

As web agents are pinged by the data center health service after registration, the health check information from them may be lost if the service instance responsible for them is dead or cannot connect. This can be prevented using one of three options. In the first option, web agents can become aware when they haven't received poll requests by the data center health service after a predetermined amount of time, and then may ping the data center health service and potentially reregister with the service in another region if necessary. The drawback of this option is that it can create a circular dependency between the web agents and the data center health service. In the second option, the reregistration of the web agents can be the responsibility of a separate web agents registration service, which also monitors the data center health service if it is available in the corresponding region. In the third option, nothing is done. This option reduces complexity and simply waits for the recovery of the affected data health service nodes.

In an example embodiment, the solution may further include an aggregation layer in the form of one or more monitoring service. Specifically, some of the functionality described above with respect to the data center health service is offloaded to the one or more monitoring services. This aggregation layer performs the actions of collecting results from web agents and aggregating the results. The aggregated results may then be passed to the data center health service, which operates as an analytical layer. This leads to a three-layer solution, with the analytical layer at the top, the aggregation layer in the middle, and the web agents at the bottom.

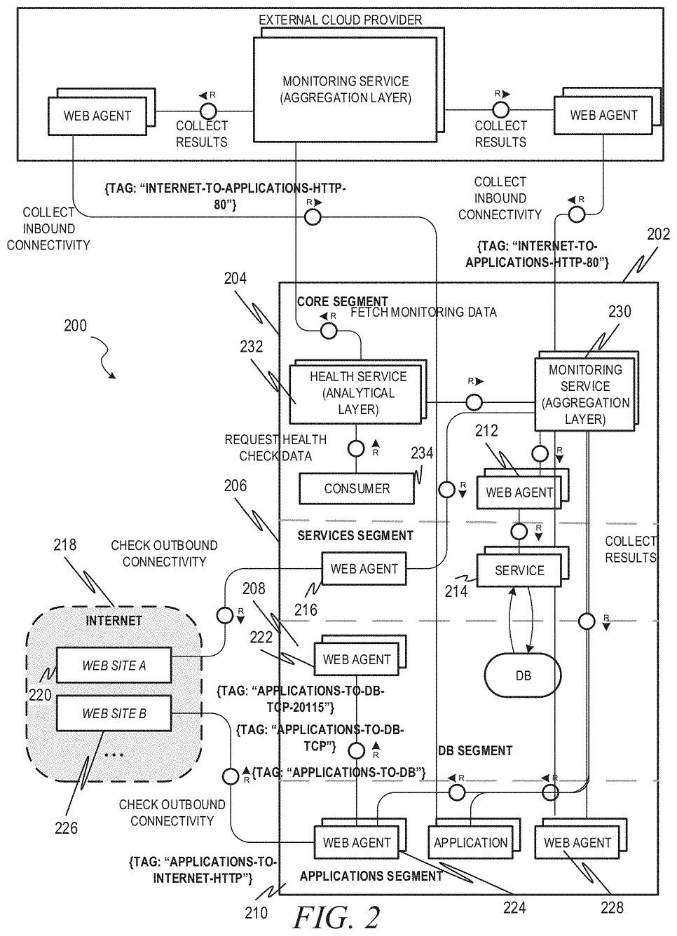

The solution may be implemented in either a single data center or multiple data center embodiment. FIG. 2 is a block diagram illustrating a single data center architecture 200 in accordance with an example embodiment. Here, cloud platform 202 includes a core segment 204, services segment 206, database segment 208, and applications segment 210. It should be noted that these segments are merely examples of segments that may be contained in a cloud platform 202 and the solution may be implemented on any segment(s). Core segment 204 contains one or more web agents 212 that monitor communications between the core segment 204 and a service 214 in the services segment 206. The services segment 206 may have its own one or more web agents 216 monitoring communications between the services segment 206 and the Internet 218, specifically web site A 220.

The database segment 208 may have its own one or more web agents 222 monitoring communications between the applications segment 210 and the database segment 208. The applications segment 210 may have two sets of web agents. Specifically, one or more web agents 224 may monitor communications between the applications segment 210 and web site B 226, while one or more web agents 226 may monitor communications between the applications segment 210 and the service 214 in the services segment 206.

All of the web agents 212, 216, 222, 224, 228 in the cloud platform 202 may be polled by a monitoring service 230, which aggregates all the tags generated by the web agents 212, 216, 222, 224, 228 and sent in response to the polling. The aggregated results may then be passed to a health service 232, which then can be queried by consumer 234 to see specific health check data based on the tags.

Furthermore, external cloud provider 236 may maintain its own monitoring service 238, which aggregates results from multiple sets of one or more web agents 240, 242 within the external cloud provider. For example, one or more web agents 240, 242, may monitor different types of inbound communications from the Internet to the applications segment 210 of the cloud platform 202. Aggregated results from the external cloud provider 236 may be passed to the health service 232 on the cloud platform 202, and may also be queried by the consumer 234.

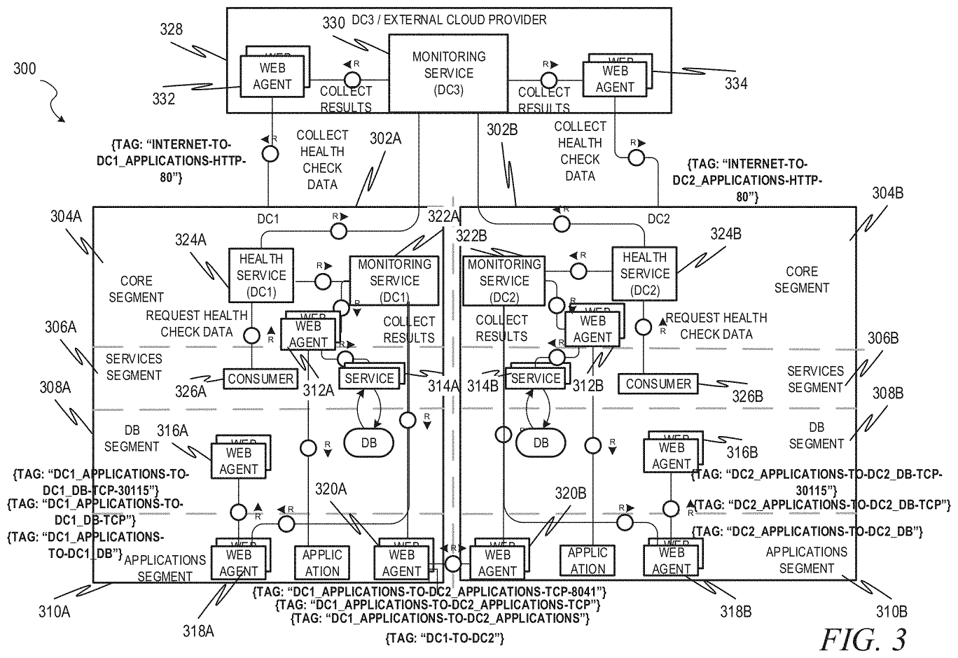

FIG. 3 is a block diagram illustrating a multi-data center architecture 300 in accordance with an example embodiment. Here, there data center DC1 302A contains core segment 304A, services segment 306A, database segment 308A, and applications segment 310A, while data center DC2 302B contains core segment 304B, services segment 306B, database segment 308B, and applications segment 310B. Core segments 304A, 304B contains one or more web agents 312A, 312B that monitor communications between the core segment 304A, 304B and a service 314A, 314 in the services segment 306A, 306B.

The database segment 308A, 308B may have its own one or more web agents 316A, 316B monitoring communications from the applications segment 310A, 310B to the database segment 308A, 308B. The applications segment 310A, 310B may have two sets of web agents. Specifically, one or more web agents 318A, 318B may monitor communications from the applications segment 310A, 310B to one external web site, while one or more web agents 320A, 320B may ping each other to monitor communications between the applications segments 310A, 310B.

All of the web agents 312A, 316A, 318A, 320A in data center DC1 302A may be polled by a monitoring service 322A, which aggregates all the tags generated by the web agents 312A, 316A, 318A, 320A and sent in response to the polling. The aggregated results may then be passed to a health service 324A, which then can be queried by consumer 326A to see specific health check data based on the tags.

All of the web agents 312B, 316B, 318B, 320B in data center DC2 302B may be polled by a monitoring service 322B, which aggregates all the tags generated by the web agents 312B, 316B, 318B, 320B and sent in response to the polling. The aggregated results may then be passed to a health service 324B, which then can be queried by consumer 326B to see specific health check data based on the tags.

Furthermore, external cloud provider 328 may maintain its own monitoring service 330, which aggregates results from multiple sets of one or more web agents 332, 334 within the external cloud provider. For example, one or more web agents 332 may monitor different types of inbound communications from the Internet to the applications segment 310A of the data center DC1 302A, while one or more web agents 334 may monitor different types of inbound communications from the Internet to the applications segment 310B of the data center DC2 302B. Aggregated results from the external cloud provider 328 may be passed to the health services 324A, 324B on the data centers 302A, 302B, respectively, and may also be queried by the consumers 326A, 326B.

In order to distinguish between services and web agent running in one data center or the other, in an example embodiment an orchestrator may perform deployments in a particular data center and expose it in an application's URL. The application's domain name may have the following format: <app_prefix>. <landscape host>.

In an example embodiment, various tags types may be defined to identify locations of the web agents. These may include the following:
inter-DC—web agent and probe destination are installed in different DCs
intra-DC—web agent and probe destination are installed in the same DCs
Internet-to-DC1—web agent is installed outside of both DCs, health check destination points to DC1
Internet-to-DC2—web agent is installed outside of both DCs, health check destination points to DC2
DC1-to-Internet—web agent is installed inside DC1, health check destination points to DC3 (or another external endpoint)
DC2-to-Internet—web agent is installed inside DC2, health check destination points to DC3 (or another external endpoint)

Additionally, there could be further, more ‘in-depth’ variations (like DC1-to-DC2 and DC2-to-DC1 instead of inter-DC, or intra-DC1 and intra-DC2 instead of just intra-DC) if deemed necessary.

Furthermore, as described briefly above, other health check specific tags may be defined by stakeholders and/or consumers that request particular types of information. For example, a simple application may be installed in a sandbox segment of DC2 and may act as a web agent, which periodically checks the connection to a database instance in DC1. When the health service retrieves information from this agent, besides the connection status data the service stores the following properties:
tags specific to the health check which are known that are concerned with the connectivity status exactly between the sandbox segment in DC2 and the DB segment in DC1, for example: “DC2_sandbox-to-DC1_DB”;
datacenter property with value DC2 (because the web agent is located there);
health check type tag with value inter-DC because the web agents at both ends of the health check reside in different data centers.

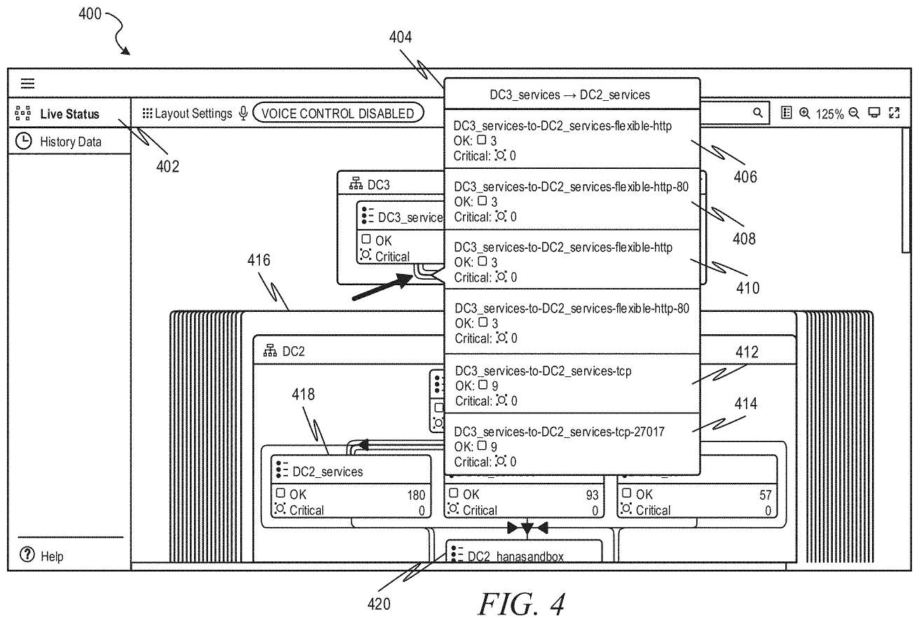

FIG. 4 is a screen capture illustrating a graphical user interface 400 for displaying health check data in accordance with an example embodiment. Here, a user/consumer has selected to see live status 402 of the health check data and has entered a query of “DC3_services->DC2_service”, indicating that the user/consumer wishes to see health check data regarding the communication between the services segment of data center 3 and the services segment of data center 2. The result is a pop-up window 404 displaying corresponding health care data, including health care data 406-414. Each of health care data 406-414 correspond to a different tag matching the user/consumer query (as can be seen all tags contain DC3_services->DC2_service. Some of these pieces of health care data, such as health care data 406 and 408 represent the same or overlapping health care data tagged with two separate matching tags at different granularities.

Additionally, a virtualization 416 of the organization of the second data center is depicted, including how the services segment 418 connects to a sandbox segment 420.

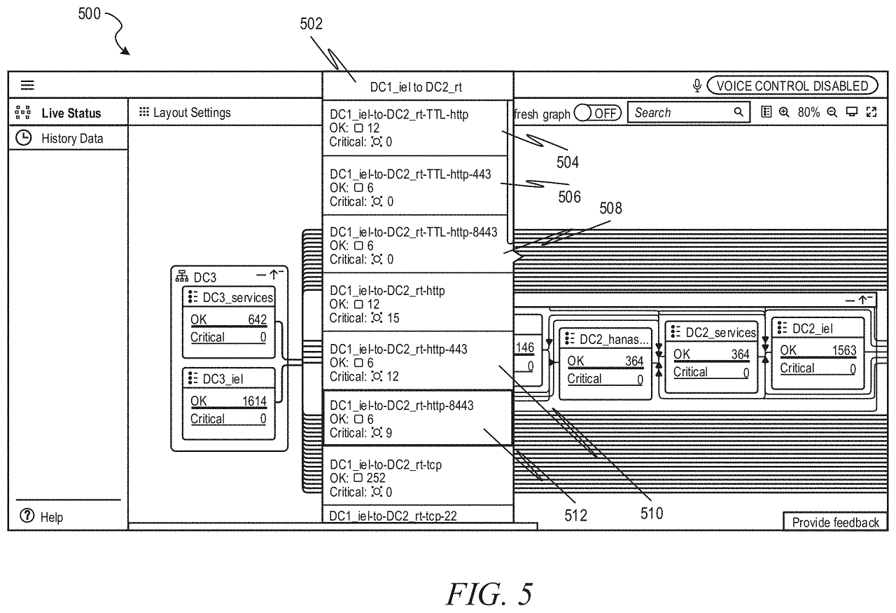

FIG. 5 is a screen capture illustrating a graphical user interface 500 for displaying health check data in accordance with another example embodiment. Here, a user/consumer has entered a query of “DC1_iel-to-DC_rt”, indicating that the user/consumer wishes to see health check data regarding the communication between the network segment named “iel” and the network segment named “rt.” The result is a pop-up window 502 displaying corresponding health care data, including health care data 504-512. Each of health care data 504-512 correspond to a different tag matching the user/consumer query (as can be seen all tags contain DC1_iel-to-DC_rt). Some of these pieces of health care data, such as health care data 504 and 506 represent the same or overlapping health care data tagged with two separate matching tags at different granularities.

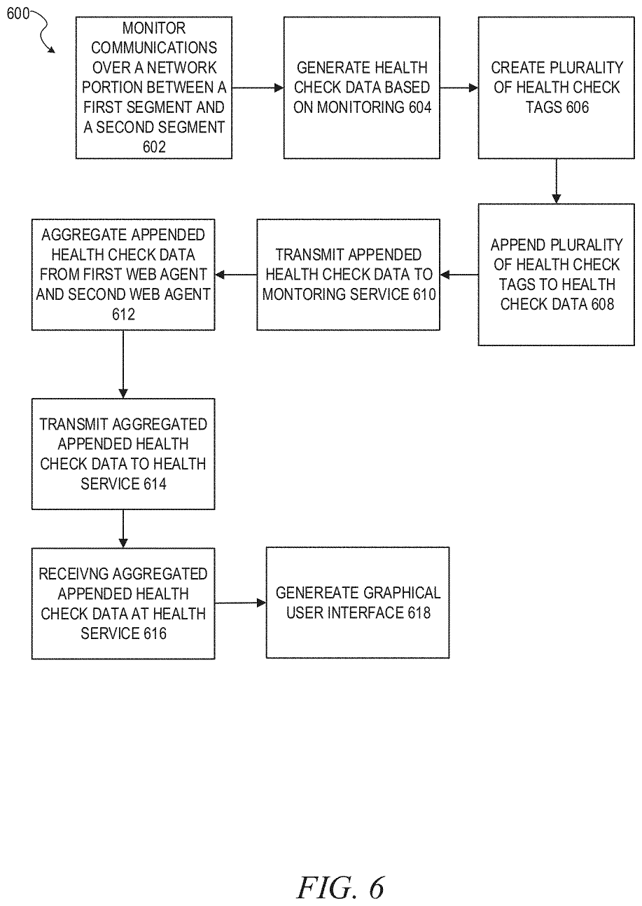

FIG. 6 is a flow diagram illustrating a method 600 for generating health check data in a data center, in accordance with an example embodiment. Operations 602-610 may be performed repeatedly by a plurality of different web agents. At operation 602, communications over a network portion between a first segment of a cloud platform operating in the first data center and a second segment of the cloud platform are monitored. The network portion has a plurality of attributes, including, for example, location (e.g., which two segments the communications between which are being monitored, port, and protocol).

At operation 604, health check data is generated based on the monitoring. This may include, for example, a score or other relative or absolute indication indicating the speed or quality of the communications between the segments. In some example embodiments, it may simply be a binary (e.g., in communication or not in communication). At operation 606, a plurality of health check tags is created, each health check tag identifying a different combination of one or more attributes in the plurality of attributes. At operation 608, the plurality of health check tags is appended to the health check data.

At operation 610, the appended health check data is transmitted to a monitoring service in an aggregation layer of the data center. At operation 612, the appended health check data from a first web agent and the appended health check data from a second web agent are aggregated. While this example is only described in the context of two web agents, in an example embodiment the health check data from all web agents that transmit such data is appended. At operation 614, the aggregated appended health check data is transmitted to a health service in the data center on demand/request.

At operation 616, the aggregated appended health check data is received at the health service. Then, at operation 618 a graphical user interface in which users can query one or more terms contained in the tags in the aggregated appended health check data to identify health check data corresponding to the terms based on the tags is generated, wherein the health service then generates a visual indication of the corresponding health check data in the graphical user interface. More particularly, in an example embodiment, an application connects to the health service to retrieve the necessary health check data and then generates the virtual indication of the corresponding health check data in the graphical user interface. Furthermore, in some example embodiment this application acts as a consumer external to the health service and is separated from it while in another implementation the application can be part of the health service itself (e.g., as an additional layer in its logic).

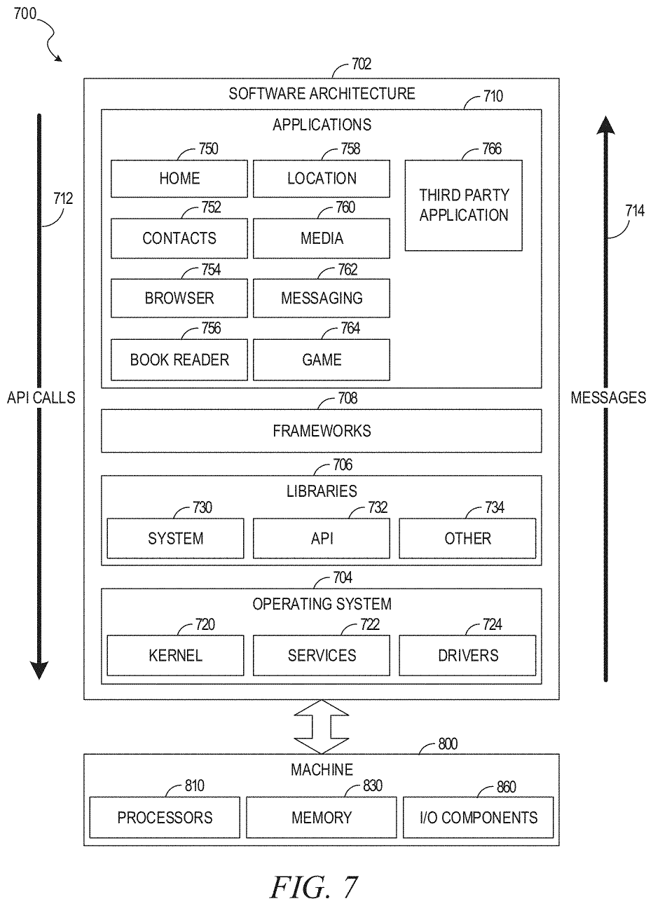

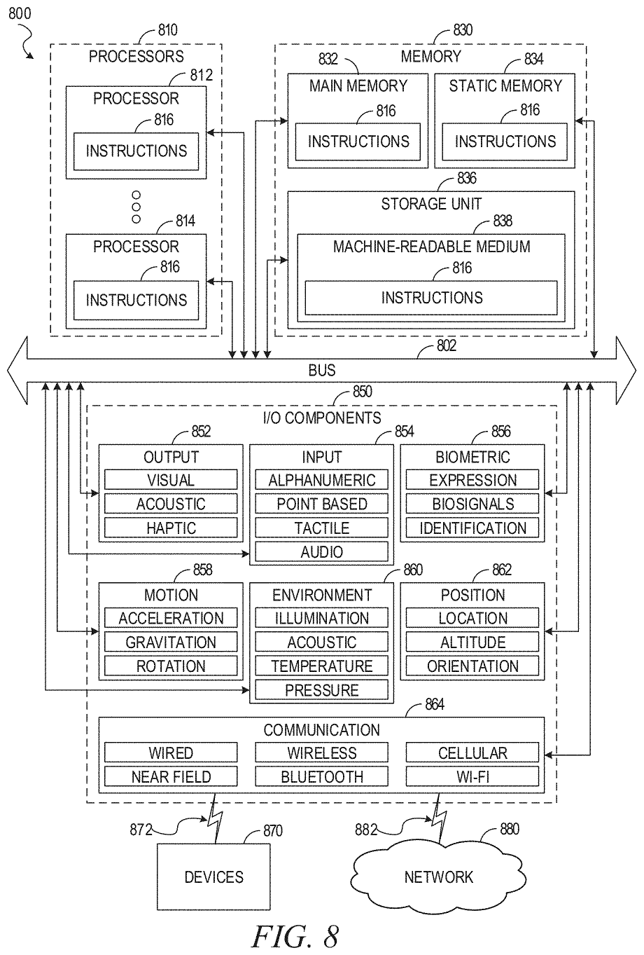

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that includes processors 810, memory 830, and input/output (I/O) components 850. In this example architecture, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke application programming interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic context on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphical user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 700 of FIG. 7. Additionally, or alternatively, the instructions 816 may implement FIGS. 1-7 and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor 812), multiple processors 812, 814 with a single core, multiple processors 812, 814 with multiple cores, or any combination thereof.

The memory 830 may include a main memory 832, a static memory 834, and a storage unit 836, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., coupled via a USB).

Moreover, the communication components 864 may detect identifiers or include components operable to detect identifiers. For example, the communication components 864 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (i.e., 830, 832, 834, and/or memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., Hypertext Transfer Protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

In view of the above described implementations of subject matter this application discloses the following list of examples, wherein one feature of an example in isolation or more than one feature of an example taken in combination and, optionally, in combination with one or more features of one or more further examples, are further examples also falling within the disclosure of this application.

Example 1. A system comprising:

at least one hardware processor; and

a computer-readable medium storing instructions that, when executed by the at least one hardware processor, cause the at least one hardware processor to perform operations comprising:

monitoring, at a first web agent in a first data center, communications over a network portion between a first segment of a cloud platform operating in the first data center and a second segment of the cloud platform, the network portion having a plurality of attributes;

generating, at the first web agent, health check data based on the monitoring;

creating a plurality of health check tags, each health check tag identifying a different combination of one or more attributes in the plurality of attributes;

appending the plurality of health check tags to the health check data; and

transmitting the appended health check data to an aggregation layer for aggregation with appended health check data from a second web agent in the first data center.

Example 2. The system of Example 1, wherein the communications are performed over a first port in a first protocol

Example 3. The system of Example 2, wherein the plurality of health check tags comprise a first tag including an identification of the network portion, the first protocol, and the first port a second tag including only the identification of the network portion, and a third tag including only the identification of the network portion and the first protocol.

Example 4. The system of any of Examples 1-3, where the operations further comprise:

receiving, at a monitoring service, the appended health check data from the first web agent and the appended health check data from the second web agent;

aggregating, at the monitoring service, the appended health check data from the first web agent and the appended health check data from the second web agent; and

transmitting the aggregated appended health check data to a health service in the data center.

Example 5. The system of Example 4, wherein the operations further comprise:

receiving, at the health service, the aggregated appended health check data;

generating, at the health service, a graphical user interface in which users can query one or more terms contained in the tags in the aggregated appended health check data to identify health check data corresponding to the terms based on the tags, wherein the health service then generates a visual indication of the corresponding health check data in the graphical user interface.

Example 6. The system of any of Examples 1-5, wherein the second web agent monitors the same network portion and protocol as the first web agent, but a different port.

Example 7. The system of Example 5, wherein the operations further comprise:

receiving, at the health service, aggregated appended health check data from a second monitoring service, the second monitoring service located on a second data center, the second monitoring service aggregating appended health check data from a third and fourth web agent located on the second data center.

Example 8. The system of any of Examples 1-7, wherein the second web agent monitors a network portion between the first segment and the Internet.

Example 9. A method comprising:

monitoring, at a first web agent in a first data center, communications over a network portion between a first segment of a cloud platform operating in the first data center and a second segment of the cloud platform, the network portion having a plurality of attributes;

generating, at the first web agent, health check data based on the monitoring;

creating a plurality of health check tags, each health check tag identifying a different combination of one or more attributes in the plurality of attributes;

appending the plurality of health check tags to the health check data; and

transmitting the appended health check data to an aggregation layer for aggregation with appended health check data from a second web agent in the first data center.

Example 10. The method of Example 9, wherein the communications are performed over a first port in a first protocol

Example 11. The method of Example 10, wherein the plurality of health check tags comprise a first tag including an identification of the network portion, the first protocol, and the first port a second tag including only the identification of the network portion, and a third tag including only the identification of the network portion and the first protocol.

Example 12. The method of any of Examples 9-11, further comprising:

receiving, at a monitoring service, the appended health check data from the first web agent and the appended health check data from the second web agent;

aggregating, at the monitoring service, the appended health check data from the first web agent and the appended health check data from the second web agent; and

transmitting the aggregated appended health check data to a health service in the data center.

Example 13. The method of Example 12, further comprising:

receiving, at the health service, the aggregated appended health check data;

generating, at the health service, a graphical user interface in which users can query one or more terms contained in the tags in the aggregated appended health check data to identify health check data corresponding to the terms based on the tags, wherein the health service then generates a visual indication of the corresponding health check data in the graphical user interface.

Example 14. The method of any of Examples 9-13, wherein the second web agent monitors the same network portion and protocol as the first web agent, but a different port.

Example 15. A non-transitory machine-readable medium storing instructions which, when executed by one or more processors, cause the one or more processors to perform operations comprising:

monitoring, at a first web agent in a first data center, communications over a network portion between a first segment of a cloud platform operating in the first data center and a second segment of the cloud platform, the network portion having a plurality of attributes;

generating, at the first web agent, health check data based on the monitoring;

creating a plurality of health check tags, each health check tag identifying a different combination of one or more attributes in the plurality of attributes;

appending the plurality of health check tags to the health check data; and

transmitting the appended health check data to an aggregation layer for aggregation with appended health check data from a second web agent in the first data center.

Example 16. The non-transitory machine-readable medium of Example 15, wherein the communications are performed over a first port in a first protocol

Example 17. The non-transitory machine-readable medium of Example 16, wherein the plurality of health check tags comprise a first tag including an identification of the network portion, the first protocol, and the first port a second tag including only the identification of the network portion, and a third tag including only the identification of the network portion and the first protocol.

Example 18. The non-transitory machine-readable medium of any of Examples 15-17, where the operations further comprise:

receiving, at a monitoring service, the appended health check data from the first web agent and the appended health check data from the second web agent;

aggregating, at the monitoring service, the appended health check data from the first web agent and the appended health check data from the second web agent; and

transmitting the aggregated appended health check data to a health service in the data center.

Example 19. The non-transitory machine-readable medium of Example 18, wherein the operations further comprise:

receiving, at the health service, the aggregated appended health check data;

generating, at the health service, a graphical user interface in which users can query one or more terms contained in the tags in the aggregated appended health check data to identify health check data corresponding to the terms based on the tags, wherein the health service then generates a visual indication of the corresponding health check data in the graphical user interface.

Example 20. The non-transitory machine-readable medium of any of Examples 15-19, wherein the second web agent monitors the same network portion and port as the first web agent, but a different protocol.

1. A system comprising:
at least one hardware processor; and
a computer-readable medium storing instructions that, when executed by the at least one hardware processor, cause the at least one hardware processor to perform operations comprising:
monitoring, at a first web agent in a first data center, communications over a network portion between a first segment of a cloud platform operating in the first data center and a second segment of the cloud platform, the network portion having a plurality of attributes;
performing a health check on the network portion by calculating one or more metrics related to connectivity based on the monitored communications;
generating, at the first web agent, health check data based on results of the health check;
creating a plurality of health check tags, each health check tag identifying a different combination of one or more attributes in the plurality of attributes;
appending the plurality of health check tags to the health check data; and
transmitting the appended health check data to an aggregation layer for aggregation with appended health check data from a second web agent in the first data center.

2. The system of claim 1, wherein the communications are performed over a first port in a first protocol.

3. The system of claim 2, wherein the plurality of health check tags comprise a first tag including an identification of the network portion, the first protocol, and the first port, a second tag including only the identification of the network portion, and a third tag including only the identification of the network portion and the first protocol.

4. The system of claim 1, where the operations further comprise:
receiving, at a monitoring service, the appended health check data from the first web agent and the appended health check data from the second web agent;
aggregating, at the monitoring service, the appended health check data from the first web agent and the appended health check data from the second web agent; and
transmitting the aggregated appended health check data to a health service in the data center.

5. The system of claim 4, wherein the operations further comprise:
receiving, at the health service, the aggregated appended health check data;
generating, at the health service, a graphical user interface in which users can query one or more terms contained in the tags in the aggregated appended health check data to identify health check data corresponding to the terms based on the tags, wherein the health service then generates a visual indication of the corresponding health check data in the graphical user interface.

6. The system of claim 1, wherein the second web agent monitors the same network portion and protocol as the first web agent, but a different port.

7. The system of claim 5, wherein the operations further comprise:
receiving, at the health service, aggregated appended health check data from a second monitoring service, the second monitoring service located on a second data center, the second monitoring service aggregating appended health check data from a third and fourth web agent located on the second data center.

8. The system of claim 1, wherein the second web agent monitors a network portion between the first segment and the Internet.

9. A method comprising:
monitoring, at a first web agent in a first data center, communications over a network portion between a first segment of a cloud platform operating in the first data center and a second segment of the cloud platform, the network portion having a plurality of attributes;
performing a health check on the network portion by calculating one or more metrics related to connectivity based on the monitored communications;
generating, at the first web agent, health check data based on results of the health check;
creating a plurality of health check tags, each health check tag identifying a different combination of one or more attributes in the plurality of attributes;
appending the plurality of health check tags to the health check data; and
transmitting the appended health check data to an aggregation layer for aggregation with appended health check data from a second web agent in the first data center.

10. The method of claim 9, wherein the communications are performed over a first port in a first protocol

11. The method of claim 10, wherein the plurality of health check tags comprise a first tag including an identification of the network portion, the first protocol, and the first port, a second tag including only the identification of the network portion, and a third tag including only the identification of the network portion and the first protocol.

12. The method of claim 9, further comprising:
receiving, at a monitoring service, the appended health check data from the first web agent and the appended health check data from the second web agent;
aggregating, at the monitoring service, the appended health check data from the first web agent and the appended health check data from the second web agent; and
transmitting the aggregated appended health check data to a health service in the data center.

13. The method of claim 12, further comprising:
receiving, at the health service, the aggregated appended health check data;
generating, at the health service, a graphical user interface in which users can query one or more terms contained in the tags in the aggregated appended health check data to identify health check data corresponding to the terms based on the tags, wherein the health service then generates a visual indication of the corresponding health check data in the graphical user interface.

14. The method of claim 9, wherein the second web agent monitors the same network portion and protocol as the first web agent, but a different port.

15. A non-transitory machine-readable medium storing instructions which, when executed by one or more processors, cause the one or more processors to perform operations comprising:
monitoring, at a first web agent in a first data center, communications over a network portion between a first segment of a cloud platform operating in the first data center and a second segment of the cloud platform, the network portion having a plurality of attributes;
performing a health check on the network portion by calculating one or more metrics related to connectivity based on the monitored communications;
generating, at the first web agent, health check data based on results of the health check;
creating a plurality of health check tags, each health check tag identifying a different combination of one or more attributes in the plurality of attributes;
appending the plurality of health check tags to the health check data; and
transmitting the appended health check data to an aggregation layer for aggregation with appended health check data from a second web agent in the first data center.

16. The non-transitory machine-readable medium of claim 15, wherein the communications are performed over a first port in a first protocol

17. The non-transitory machine-readable medium of claim 16, wherein the plurality of health check tags comprise a first tag including an identification of the network portion, the first protocol, and the first port, a second tag including only the identification of the network portion, and a third tag including only the identification of the network portion and the first protocol.

18. The non-transitory machine-readable medium of claim 15, where the operations further comprise:
receiving, at a monitoring service, the appended health check data from the first web agent and the appended health check data from the second web agent;
aggregating, at the monitoring service, the appended health check data from the first web agent and the appended health check data from the second web agent; and
transmitting the aggregated appended health check data to a health service in the data center.

19. The non-transitory machine-readable medium of claim 18, wherein the operations further comprise:
receiving, at the health service, the aggregated appended health check data;
generating, at the health service, a graphical user interface in which users can query one or more terms contained in the tags in the aggregated appended health check data to identify health check data corresponding to the terms based on the tags, wherein the health service then generates a visual indication of the corresponding health check data in the graphical user interface.

20. The non-transitory machine-readable medium of claim 15, wherein the second web agent monitors the same network portion and port as the first web agent, but a different protocol.
